(19) United States
(12) Patent Application Publication
(10) Pub. No.: US 2026/0296642 A1
(43) Pub. Date: Oct. 1, 2026

(54) FLYING OBJECT AND CONTROL METHOD THEREFOR

(71) Applicant: HONDA MOTOR CO., LTD., Tokyo (JP)

(72) Inventors: Toshio Sakurai, Wako-shi (JP); Shunichiro Tamada, Wako-shi (JP); Kazuyuki Iwata, Tokyo (JP)

(21) Appl. No.: 19/629,174

(22) Filed: Mar. 26, 2026

(30) Foreign Application Priority Data
Mar. 27, 2025 (JP) 2025-054409

(51) Int. Cl. B64C 29/00; B64C 9/20; B64C 9/26

(52) U.S. Cl. CPC B64C 29/0025; B64C 9/20; B64C 9/26

(57) ABSTRACT

A flying object is equipped with first propulsion devices disposed on a front wing, second propulsion devices disposed on a rear wing, and flaps that are capable of deflecting a direction of an airflow generated by the first propulsion devices or the second propulsion devices. The flying object carries out vertical takeoff and landing by controlling one or more of the direction of the airflow generated by the first propulsion devices, the direction of the airflow generated by the second propulsion devices, and the angle of the flaps.

### CROSS-REFERENCE TO RELATED APPLICATIONS

This application is based upon and claims the benefit of priority from Japanese Patent Application No. 2025-054409 filed on March 27, 2025, the contents of which are incorporated herein by reference.

### BACKGROUND OF THE INVENTION

### Field of the Invention

The present disclosure relates to a flying object and a control method therefor.

### Description of the Related Art

WO 2023/034302 A1 discloses a flying object. The flying object includes a fuselage, a main wing provided on the fuselage, a thrust generating device provided at a front end of the main wing, and flaps provided on a rear end of the main wing. During flight of the flying object, an upwardly directed thrust is obtained by hitting a portion of a swirling flow generated by the thrust generating device and directed rearwardly against the flaps whose angle has been changed.

### SUMMARY OF THE INVENTION

In the flying object of WO 2023/034302 A1, since a predetermined distance in the direction of travel when taking off or landing is carried out, it is desirable to be capable of taking off and landing in a shorter distance. In order to enable a flying object to take off and land over a shorter distance, for example, apart from the thrust generating device that is used for horizontal movement, it may be considered to provide a rotor for vertical takeoff and landing. However, since a vertical takeoff and landing rotor is not used during cruising, a problem arises in that such a vertical takeoff and landing rotor becomes heavy.

The present invention has the object of solving the aforementioned problem.

An aspect of the present disclosure is characterized by a flying object, comprising a fuselage, a front wing connected to the fuselage, a rear wing connected to the fuselage and disposed more rearward than the front wing, a first propulsion device disposed on the front wing and configured to generate at least a rearward airflow, a second propulsion device disposed on the rear wing and configured to generate at least a rearward airflow, and a flap disposed on at least one of the front wing or the rear wing in a tiltable manner, and configured to deflect a direction of an airflow generated by the first propulsion device or the second propulsion device, wherein a vertical takeoff and landing is carried out by controlling one or more of the direction of the airflow generated by the first propulsion device, the direction of the airflow generated by the second propulsion device, and an angle of the flap.

According to the present disclosure, since the vertical takeoff and landing of the flying object becomes possible without providing a rotor for such vertical takeoff and landing, it is possible to realize a reduction in weight of the flying object. Further, the flying object is capable of carrying out the takeoff and landing in locations where there are no runways.

The above and other objects, features, and advantages of the present invention will become more apparent from the following description when taken in conjunction with the accompanying drawings, in which a preferred embodiment of the present invention is shown by way of illustrative example.

### BRIEF DESCRIPTION OF THE DRAWINGS

FIG. 1 is a plan view of a flying object according to a first embodiment of the present disclosure;

FIG. 2 is a side view of the flying object shown in FIG. 1;

FIG. 3 is a first explanatory diagram of operations of the flying object shown in FIG. 2;

FIG. 4A is a second explanatory diagram of operations of the flying object shown in FIG. 2;

FIG. 4B is a third explanatory diagram of operations of the flying object shown in FIG. 2;

FIG. 5 is a fourth explanatory diagram of operations of the flying object shown in FIG. 2;

FIG. 6 is a plan view of a flying object according to a second embodiment of the present disclosure;

FIG. 7 is a side view of the flying object shown in FIG. 6;

FIG. 8A is a first explanatory diagram of operations of the flying object shown in FIG. 7;

FIG. 8B is a second explanatory diagram of operations of the flying object shown in FIG. 7;

FIG. 9 is a third explanatory diagram of operations of the flying object shown in FIG. 7;

FIG. 10A is a fourth explanatory diagram of operations of the flying object shown in FIG. 7;

FIG. 10B is a fifth explanatory diagram of operations of the flying object shown in FIG. 7;

FIG. 11 is a plan view of a flying object according to a third embodiment of the present disclosure;

FIG. 12 is a side view of the flying object shown in FIG. 11;

FIG. 13A is a first explanatory diagram of operations of the flying object shown in FIG. 12;

FIG. 13B is a second explanatory diagram of operations of the flying object shown in FIG. 12;

FIG. 14 is a third explanatory diagram of operations of the flying object shown in FIG. 12;

FIG. 15 is a plan view of a flying object according to a fourth embodiment of the present disclosure;

FIG. 16 is a side view of the flying object shown in FIG. 15;

FIG. 17A is a first explanatory diagram of operations of the flying object shown in FIG. 16;

FIG. 17B is a second explanatory diagram of operations of the flying object shown in FIG. 16; and

FIG. 18 is a third explanatory diagram of operations of the flying object shown in FIG. 16.

### DETAILED DESCRIPTION OF THE INVENTION

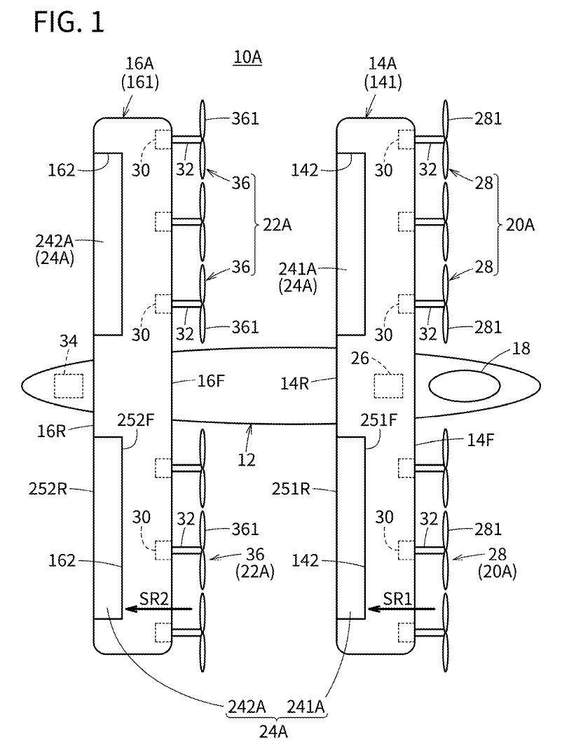

As shown in FIG. 1, a flying object 10A according to a first embodiment is equipped with a fuselage 12, a front wing 14A, and a rear wing 16A. The fuselage 12 is formed long along a front-rear direction of the flying object 10A. A cockpit 18 in which a non-illustrated pilot is capable of sitting is provided in the fuselage 12. Moreover, it should be noted that the flying object 10A is capable of being piloted in an automatic manner without providing the cockpit 18.

Each of the front wing 14A and the rear wing 16A is connected to the fuselage 12. The front wing 14A and the rear wing 16A are formed in the same shape. Moreover, it should be noted that the front wing 14A and the rear wing 16A may be formed with different shapes.

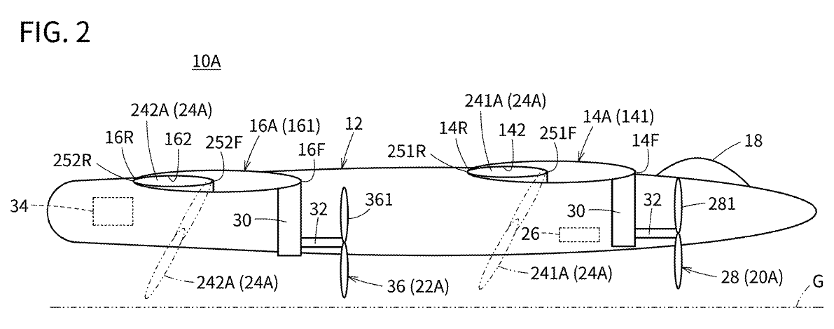

Each of the front wing 14A and the rear wing 16A extend respectively in a widthwise direction that is perpendicular to the front-rear direction of the fuselage 12. As shown in FIG. 2, in a side view of the flying object 10A, each of the front wing 14A and the rear wing 16A is a high wing that is disposed on an upper part of the fuselage 12. Moreover, it should be noted that each of the front wing 14A and the rear wing 16A is not necessarily limited to having a configuration of being disposed on the upper part of the fuselage 12. For example, each of the front wing 14A and the rear wing 16A may be configured in a manner so as to be disposed on an intermediate part between the upper part and a lower part of the fuselage 12.

As shown in FIG. 1, the front wing 14A is disposed on a front part of the fuselage 12. The front wing 14A is equipped with a pair of front wing portions 141 that extend toward both sides in the widthwise direction with respect to the fuselage 12. The rear wing 16A is disposed on a rear part of the fuselage 12. The rear wing 16A is disposed more rearward than the front wing 14A. The rear wing 16A is equipped with a pair of rear wing portions 161 that extend toward both sides in the widthwise direction with respect to the fuselage 12.

The flying object 10A further includes first propulsion devices 20A, second propulsion devices 22A, flaps 24A, and a control device 26 including a non-illustrated computation unit. The computation unit is constituted by a processor (processing circuitry) such as a central processing unit (CPU). The flying object 10A carries out vertical takeoff and landing by controlling, by means of the control device 26, the direction of the airflow generated by the first propulsion devices 20A and the second propulsion devices 22A, and an angle of the flaps 24A.

The first propulsion devices 20A are disposed on the front wing 14A and are capable of generating at least a rearward airflow (first rearward airflow SR1). As shown in FIG. 2, the first propulsion devices 20A are equipped with a plurality of first propeller devices 28. The plurality of first propeller devices 28 are disposed on a lower part of each of the pair of front wing portions 141. Each of the plurality of first propeller devices 28 is disposed on a front end part 14F of the front wing 14A. The plurality of first propeller devices 28 are disposed in a manner so as to extend frontward from the front end parts 14F of the front wing portions 141. As shown in FIG. 1, the plurality of first propeller devices 28 are disposed to be spaced apart from each other in the direction in which the pair of front wing portions 141 extend. Hereinafter, a description will be given concerning a configuration in which three of the first propeller devices 28 are disposed on each of the pair of front wing portions 141. In this case, the front wing 14A is provided with a total of six of the first propeller devices 28.

Moreover, it should be noted that the number of the first propeller devices 28 is not necessarily limited to being six. The number of the first propeller devices 28 on the front wing 14A may be less than or equal to five, or greater than or equal to seven.

The plurality of first propeller devices 28 are equipped with first propellers 281 and motive power devices 30. The first propellers 281 are disposed in a manner so as to face frontward with respect to the front wing 14A. The first propellers 281 are connected to rotation shafts 32 of the motive power devices 30. The motive power devices 30 are motors. The motive power devices 30 are rotatably driven by electric power from a battery 34. The rotation shafts 32 of the motive power devices 30 are parallel to the front-rear direction of the fuselage 12. The battery 34 is disposed on a rear end part of the fuselage 12. By disposing the battery 34 on the rear end part of the fuselage 12, the center of gravity of the flying object 10A can be positioned in closer proximity to the rear part of the fuselage 12.

In the first propeller devices 28, the first propellers 281 are provided to be capable of rotating in a forward direction about the rotation shafts 32. Hereinafter, the forward rotation of the first propellers 281 may also be referred to as a first forward rotation. By being operated by the non-illustrated pilot, the first propellers 281 undergo the first forward rotation based on a control signal from the control device 26. By the first propeller devices 28 being made to undergo the first forward rotation, the first propellers 281 generate a first rearward airflow SR1 that flows rearward along the lower part of the front wing 14A. The first rearward airflow SR1 becomes a thrust force when the flying object 10A moves frontward. Moreover, it should be noted that the first propellers 281 are not necessarily limited to having a configuration capable of rotating only in a forward direction about the rotation shafts 32. For example, the first propellers 281 may be capable of rotating in a forward direction and a reverse direction.

The second propulsion devices 22A are disposed on the rear wing 16A and are capable of generating at least a rearward airflow (second rearward airflow SR2). The second propulsion devices 22A are equipped with a plurality of second propeller devices 36. The plurality of second propeller devices 36 are disposed on a lower part of each of the pair of rear wing portions 161. Each of the plurality of second propeller devices 36 are disposed on a front end part 16F of the rear wing 16A. The plurality of second propeller devices 36 are disposed in a manner so as to extend frontward from the front end parts 16F of the rear wing portions 161. The plurality of second propeller devices 36 are disposed to be spaced apart from each other in the direction in which the pair of rear wing portions 161 extend. Hereinafter, a description will be given concerning a configuration in which three of the second propeller devices 36 are disposed on each of the pair of rear wing portions 161. In this case, the rear wing 16A is provided with a total of six of the second propeller devices 36.

Moreover, it should be noted that the number of the second propeller devices 36 is not necessarily limited to being six. The number of the second propeller devices 36 may be less than or equal to five, or greater than or equal to seven.

The number of the second propeller devices 36 and the number of the first propeller devices 28 are the same. In the front-rear direction of the fuselage 12, each of the second propeller devices 36 and each of the first propeller devices 28 are disposed in a straight line shape. Moreover, it should be noted that the number of the second propeller devices 36 and the number of the first propeller devices 28 may be different.

The plurality of second propeller devices 36 are equipped with second propellers 361 and motive power devices 30. Moreover, concerning the motive power devices 30, since they are similar to the motive power devices 30 of the first propeller devices 28, the same reference numerals are applied thereto, and detailed description thereof is omitted. The second propellers 361 are disposed in a manner so as to face frontward with respect to the rear wing 16A. The second propellers 361 are connected to the rotation shafts 32 of the motive power devices 30.

In each of the second propeller devices 36, the second propellers 361 are disposed to be capable of rotating in a forward direction about the rotation shafts 32. Hereinafter, the forward rotation of the second propellers 361 may also be referred to as a second forward rotation. By being operated by the non-illustrated pilot, the second propellers 361 undergo the second forward rotation based on a control signal from the control device 26, whereby the second propellers 361 generate a second rearward airflow SR2 that flows rearward along the lower part of the rear wing 16A. The second rearward airflow SR2 becomes a thrust force when the flying object 10A moves frontward. Moreover, it should be noted that the second propellers 361 are not necessarily limited to having a configuration capable of rotating only in a forward direction about the rotation shafts 32. For example, the second propellers 361 may be capable of rotating in a forward direction and a reverse direction.

The flaps 24A are equipped with first flaps 241A and second flaps 242A.

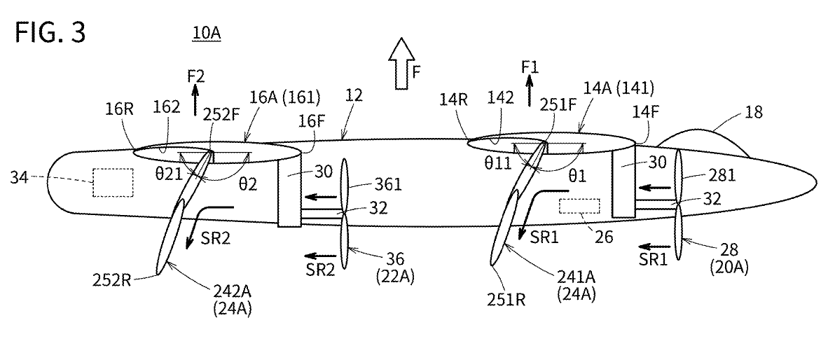

As shown in FIG. 3, the first flaps 241A are disposed on the front wing 14A in a tiltable manner. As shown in FIG. 3, the first flaps 241A are disposed in a manner so as to be capable of deflecting the direction of the first rearward airflow SR1 that is generated by the first propulsion devices 20A. As shown in FIG. 1, the first flaps 241A are disposed on the pair of front wing portions 141, respectively. More specifically, a pair of the first flaps 241A are provided. Moreover, it should be noted that the number of the first flaps 241A is not necessarily limited to one pair. For example, two or more of the first flaps 241A may be provided on each of the front wing portions 141.

The pair of first flaps 241A are disposed on rear end parts 14R of the front wing portions 141. In the respective front wing portions 141, the first flaps 241A are disposed rearward of the first propulsion devices 20A. The respective first flaps 241A are formed in a rectangular shape that is long in the widthwise direction of the front wing portions 141, and short in the front-rear direction of the fuselage 12. The respective first flaps 241A are disposed in first storage units 142 of the front wing portions 141. The respective first storage units 142 are disposed on the rear end parts 14R of the front wing portions 141. The respective first storage units 142 are formed to be recessed in a rectangular shape from the rear end parts 14R of the front wing portions 141 toward the front.

As shown in FIG. 2, front end parts 251F of the first flaps 241A are supported in a tiltable manner by the front wing portions 141 in the interior of the first storage units 142. The respective first flaps 241A include rear end parts 251R that are capable of tilting about the front end parts 251F with respect to the front wing portions 141. When the respective first flaps 241A tilt, the respective first flaps 241A are each constituted from a plurality of members that extend in a manner so that the rear end parts 251R separate away from the front wing portions 141. The initial position of the respective first flaps 241A is in a state in which the respective first flaps 241A are stored in the first storage units 142 and are parallel to the front wing portions 141. Moreover, it should be noted that the respective first flaps 241A are not necessarily limited to having a configuration in which the rear end parts 251R extend in a manner so as to separate away from the front wing portions 141.

As shown in FIG. 3, when the respective first flaps 241A are in a tilted position, the rear end parts 251R of the first flaps 241A are tilted downward with respect to the front wing portions 141 about the front end parts 251F, and the rear end parts 251R are disposed lower than the front wing portions 141. An angle θ1 of the frontward side of the first flaps 241A with respect to the front-rear direction of the fuselage 12 is greater than or equal to 90°. The angle θ1 of the first flaps 241A is preferably greater than or equal to 120°. Hereinafter, the angle of the rearward side of the first flaps 241A with respect to the front-rear direction of the fuselage 12 will be referred to as a first flap angle θ11.

In the tilted position of the respective first flaps 241A, the first rearward airflow SR1 that is generated by the first propulsion devices 20A and that flows along the lower part of the front wing 14A can be deflected downward by the first flaps 241A. The position of each of the first flaps 241A can be adjusted by the operation of the non-illustrated pilot.

The second flaps 242A are disposed on the rear wing 16A in a tiltable manner. The second flaps 242A are disposed in a manner so as to be capable of deflecting the direction of the second rearward airflow SR2 that is generated by the second propulsion devices 22A. As shown in FIG. 1, the second flaps 242A are disposed on the pair of rear wing portions 161, respectively. More specifically, a pair of the second flaps 242A are provided. Moreover, it should be noted that the number of the second flaps 242A is not necessarily limited to one pair. For example, two or more of the second flaps 242A may be provided on each of the rear wing portions 161.

The pair of second flaps 242A are disposed on rear end parts 16R of the rear wing portions 161. In the respective rear wing portions 161, the second flaps 242A are disposed rearward of the second propulsion devices 22A. The respective second flaps 242A are formed in a rectangular shape that is long in the widthwise direction of the rear wing portions 161, and short in the front-rear direction of the fuselage 12. The respective second flaps 242A are disposed in second storage units 162 of the rear wing portions 161. The respective second storage units 162 are disposed on the rear end parts 16R of the rear wing portions 161. The respective second storage units 162 are formed to be recessed in a rectangular shape from the rear end parts 16R of the rear wing portions 161 toward the front.

As shown in FIG. 3, front end parts 252F of the second flaps 242A are supported in a tiltable manner by the rear wing portions 161 in the interior of the second storage units 162. The respective second flaps 242A include rear end parts 252R that are capable of tilting about the front end parts 252F with respect to the rear wing portions 161. When the respective second flaps 242A tilt, the respective second flaps 242A are each constituted from a plurality of members that extend in a manner so that the rear end parts 252R separate away from the rear wing portions 161. As shown in FIG. 2, the initial position of the respective second flaps 242A is in a state in which the respective second flaps 242A are stored in the second storage units 162 and are parallel to the rear wing portions 161. Moreover, it should be noted that the respective second flaps 242A are not necessarily limited to having a configuration in which the rear end parts 252R extend in a manner so as to separate away from the rear wing portions 161.

As shown in FIG. 3, when the respective second flaps 242A are in a tilted position, the rear end parts 252R of the second flaps 242A are tilted downward with respect to the rear wing portions 161 about the front end parts 252F, and the rear end parts 252R are disposed lower than the rear wing portions 161. An angle θ2 of the frontward side of the second flaps 242A with respect to the front-rear direction of the fuselage 12 is greater than or equal to 90°. The angle θ2 of the second flaps 242A is preferably greater than or equal to 120°. Hereinafter, the angle of the rearward side of the second flaps 242A with respect to the front-rear direction of the fuselage 12 will be referred to as a second flap angle θ21.

In the tilted position of the respective second flaps 242A, the second rearward airflow SR2 that is generated by the second propulsion devices 22A and that flows along the lower part of the rear wing 16A can be deflected downward by the second flaps 242A. The position of each of the second flaps 242A can be adjusted by the operation of the non-illustrated pilot.

Next, a description will be given concerning operations of the flying object 10A.

First, as shown in FIG. 2, when the flying object 10A carries out a vertical takeoff from a state of being in a landed state on a ground G, each of the first flaps 241A and the second flaps 242A are placed in a tilted position (refer to FIG. 3). As shown in FIG. 3, for example, the first flap angle θ11 of the first flaps 241A and the second flap angle θ21 of the second flaps 242A are each set to a maximum. The first propulsion devices 20A and the second propulsion devices 22A are driven by the pilot.

Specifically, electric power is supplied from the battery 34 to the motive power devices 30 of the first propeller devices 28 and the second propeller devices 36. By the respective motive power devices 30 being driven, the first propellers 281 of the plurality of first propeller devices 28 undergo the first forward rotation. By the first forward rotation of the plurality of first propeller devices 28, the first rearward airflow SR1 toward the rear of the first propeller devices 28 is generated. By the second propellers 361 of the plurality of second propeller devices 36 undergoing the second forward rotation, the second rearward airflow SR2 toward the rear of the second propeller devices 36 is generated.

The first rearward airflow SR1 that is generated by the plurality of first propulsion devices 20A is deflected downward by hitting against each of the pair of first flaps 241A. The first rearward airflow SR1 that is deflected downward becomes a first ascending thrust force F1 that causes the fuselage 12 to ascend in the vertical direction. At this time, it is preferable for the rear end parts 251R of the first flaps 241A to be tilted vertically downward.

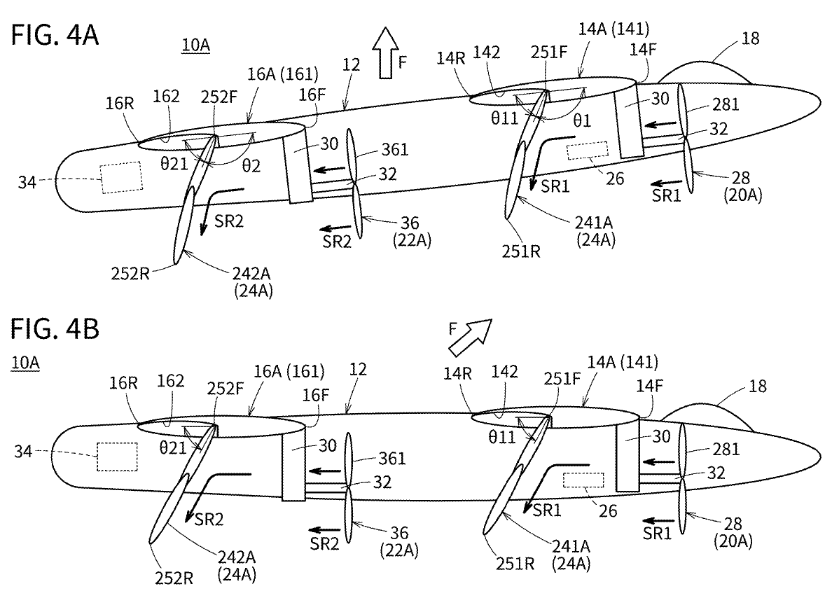

The second rearward airflow SR2 that is generated by the plurality of second propulsion devices 22A is deflected downward by hitting against each of the pair of second flaps 242A. The second rearward airflow SR2 that is deflected downward becomes a second ascending thrust force F2 that causes the fuselage 12 to ascend in the vertical direction. At this time, it is preferable for the rear end parts 252R of the second flaps 242A to be tilted vertically downward. The front part of the flying object 10A is made to rise by the first ascending thrust force F1, and the rear part of the flying object 10A is made to rise by the second ascending thrust force F2. In accordance therewith, as shown in FIG. 4A, a state is brought about in which the flying object 10A ascends in the vertical direction from the ground G and takes off.

At this time, by adjusting the output of the first propulsion devices 20A and thereby controlling the flow rate of the first rearward airflow SR1, and by adjusting the output of the second propulsion devices 22A and thereby controlling the flow rate of the second rearward airflow SR2, it is possible to control a pitch movement of the flying object 10A. A thrust force F that acts on the flying object 10A when taking off is due to the first rearward airflow SR1 and the second rearward airflow SR2 that are directed rearward of the fuselage 12. Therefore, the fuselage 12 tends to be inclined rearward in a manner so that the rear part of the fuselage 12 is positioned higher than the front part thereof, and furthermore, since the battery 34 which is a heavy object is mounted at the rear part of the fuselage 12, the fuselage 12 ascends in a slightly rearwardly inclined attitude.

Next, after the flying object 10A has taken off, by adjusting the output of the first propulsion devices 20A and the second propulsion devices 22A in a state in which the first flap angle θ11 of the first flaps 241A and the second flap angle θ21 of the second flaps 242A are maintained, an attitude control is performed in a manner so that the fuselage 12 becomes horizontal. Specifically, by the output of the second propulsion devices 22A being increased to be greater than the output of the first propulsion devices 20A, the second ascending thrust force F2 with respect to the fuselage 12 is made to be greater than the first ascending thrust force F1. Moreover, the output of the second propulsion devices 22A may be reduced to be lower than the output of the first propulsion devices 20A.

As shown in FIG. 4B, in a state in which the fuselage 12 has become substantially horizontal, the first flap angle θ11 of the first flaps 241A and the second flap angle θ21 of the second flaps 242A are adjusted in a manner so as to gradually become smaller. Specifically, by the first flap angle θ11 of the first flaps 241A being gradually made smaller, the direction in which the first rearward airflow SR1 is deflected by the first flaps 241A is gradually changed from downward to diagonally rearward. Therefore, the propulsion direction of the fuselage 12 due to the first rearward airflow SR1 gradually changes from upward to diagonally frontward.

Similarly, since the direction in which the second rearward airflow SR2 is deflected by the second flaps 242A is gradually changed from downward to diagonally rearward, the propulsion direction of the fuselage 12 due to the second rearward airflow SR2 gradually changes from upward to diagonally frontward. In accordance therewith, the flying object 10A begins to move frontward and diagonally upward. More specifically, by the first flap angle θ11 of the first flaps 241A and the second flap angle θ21 of the second flaps 242A being made smaller, the direction in which the propulsion force acts on the fuselage 12 is controlled so as to gradually become frontward.

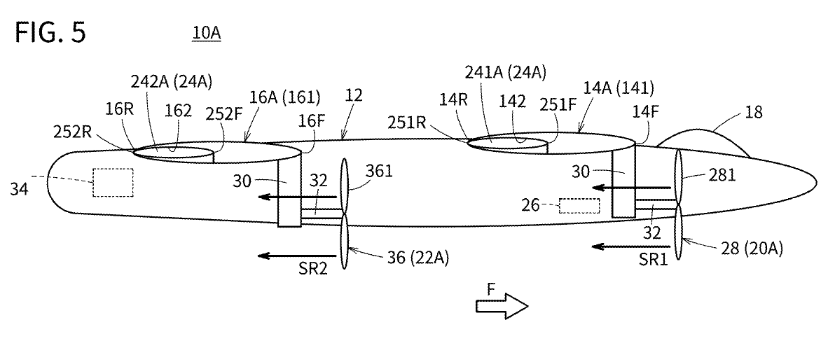

Then, as shown in FIG. 5, in a state in which the fuselage 12 of the flying object 10A has become horizontal, the first flaps 241A and the second flaps 242A are set to the initial position, whereby the first flaps 241A and the second flaps 242A are stored respectively in the first storage units 142 and the second storage units 162. At this time, in a side view of the fuselage 12, the first flaps 241A and the front wing 14A are parallel to each other, and the second flaps 242A and the rear wing 16A are parallel to each other.

By the first flaps 241A being stored in the first storage units 142, the first rearward airflow SR1 flows only rearward without being deflected by the first flaps 241A. By the second flaps 242A being stored in the second storage units 162, the second rearward airflow SR2 flows only rearward without being deflected by the second flaps 242A. In accordance therewith, each of the first rearward airflow SR1 and the second rearward airflow SR2 becomes the thrust force F that serves to propel the fuselage 12 only frontward. The thrust force F causes the flying object 10A to move frontward, and increases the speed of movement of the flying object 10A.

Next, in the case of causing the flying object 10A to land, by gradually reducing the output of the first propulsion devices 20A and the second propulsion devices 22A, the speed of movement of the flying object 10A is made to decelerate.

Together with the output of the first propulsion devices 20A and the second propulsion devices 22A being made to decelerate, the first flaps 241A and the second flaps 242A are tilted as shown in FIG. 3. The first flaps 241A and the second flaps 242A are placed in a tilted position. In accordance therewith, accompanying the output of the first propulsion devices 20A and the second propulsion devices 22A being reduced, the speed of movement of the flying object 10A gradually decreases and the flying object 10A descends due to gravity.

As shown in FIG. 2, in a state of being substantially parallel to the ground G, the flying object 10A lands on the ground G. In such a landed state, the flying object 10A is in a horizontal state. In the landed state, it is easy for the pilot and crew member to board and disembark the flying object 10A. In the landed state, it is easy to load and unload cargo to and from the flying object 10A.

The first embodiment exhibits the following advantageous effects.

As shown in FIG. 2, the flying object 10A is equipped with the first propulsion devices 20A disposed on the front wing 14A, the second propulsion devices 22A disposed on the rear wing 16A, and the flaps 24A that are capable of deflecting the direction of the airflow generated by the first propulsion devices 20A or the second propulsion devices 22A. The vertical takeoff and landing is carried out by controlling the direction of the airflow generated by the first propulsion devices 20A and the second propulsion devices 22A, and the angle of the flaps 24A.

In accordance with this configuration, since the vertical takeoff and landing of the flying object 10A becomes possible without providing a rotor for such vertical takeoff and landing, it is possible to realize a reduction in weight of the flying object 10A. Further, the flying object 10A is capable of carrying out the takeoff and landing in locations where there are no runways.

As shown in FIG. 3, the flaps 24A comprise the first flaps 241A that are disposed on the front wing 14A, and the second flaps 242A that are disposed on the rear wing 16A.

In accordance with this configuration, the flowing of each of the first rearward airflow SR1 and the second rearward airflow SR2 can be effectively deflected downward, and therefore, the flying object 10A can be made to move effectively in the vertical direction.

As shown in FIG. 1, the first flaps 241A are disposed rearward of the first propulsion devices 20A, and the second flaps 242A are disposed rearward of the second propulsion devices 22A. As shown in FIG. 3, when carrying out the vertical takeoff and landing, the first rearward airflow SR1 that is generated by the first propulsion devices 20A is deflected downward by the first flaps 241A, and the second rearward airflow SR2 that is generated by the second propulsion devices 22A is deflected downward by the second flaps 242A.

In accordance with this configuration, each of the first rearward airflow SR1 and the second rearward airflow SR2 that are directed rearward can be effectively deflected downward by the first flaps 241A and the second flaps 242A.

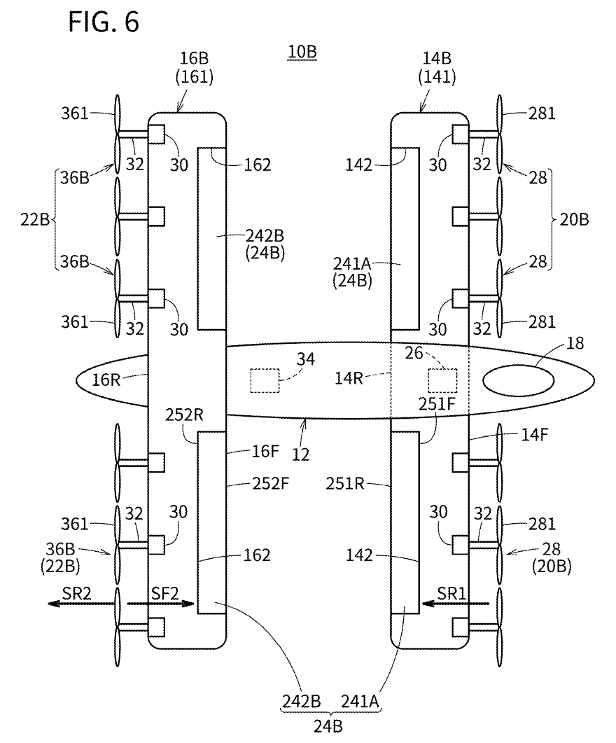

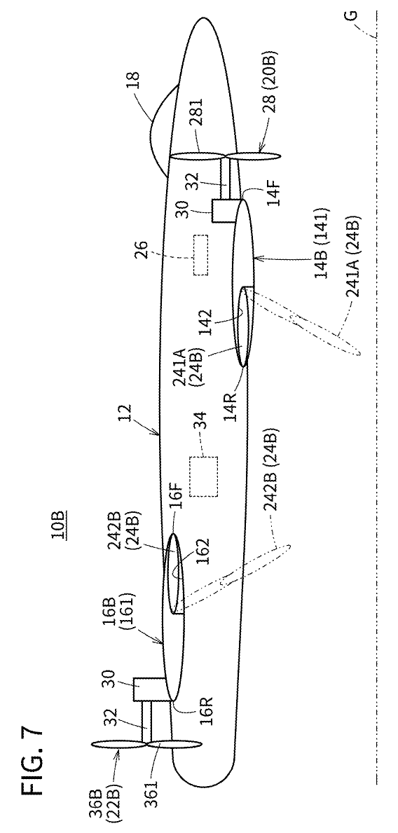

As shown in FIG. 6, a flying object 10B according to a second embodiment is equipped with a front wing 14B, a rear wing 16B, first propulsion devices 20B, second propulsion devices 22B, and flaps 24B. As shown in FIG. 7, in a side view of the flying object 10B, the front wing 14B is a low wing that is disposed on the lower part of the fuselage 12, and the rear wing 16B is a high wing that is disposed on the upper part of the fuselage 12. Moreover, it should be noted that the configuration is not necessarily limited to being one in which the front wing 14B is a low wing that is disposed on the lower part of the fuselage 12, and the rear wing 16B is a high wing that is disposed on the upper part of the fuselage 12.

As shown in FIG. 6, the first propulsion devices 20B are disposed on the front wing 14B and are capable of generating at least the first rearward airflow SR1. The first propulsion devices 20B are equipped with a plurality of the first propeller devices 28. The plurality of first propeller devices 28 are disposed on an upper part of each of the pair of front wing portions 141 (refer to FIG. 7). Moreover, since the plurality of first propeller devices 28 have the same configuration as the plurality of first propeller devices 28 in the first embodiment, the same reference numerals are applied thereto, and detailed description thereof is omitted.

In the first propeller devices 28, the first propellers 281 are provided to be capable of rotating in a forward direction about the rotation shafts 32. By being operated by the non-illustrated pilot, the first propellers 281 undergo the first forward rotation based on a control signal from the control device 26, whereby the first propellers 281 generate the first rearward airflow SR1 that flows rearward.

The second propulsion devices 22B are disposed on the rear wing 16B and are capable of generating at least the second rearward airflow SR2. The second propulsion devices 22B are equipped with a plurality of second propeller devices 36B. The plurality of second propeller devices 36B are disposed on an upper part of each of the pair of rear wing portions 161 (refer to FIG. 7). Each of the plurality of second propeller devices 36B is disposed on the rear end part 16R of the rear wing 16B. The plurality of second propeller devices 36B are disposed in a manner so as to extend rearward from the rear end parts 16R of the rear wing portions 161. The plurality of second propeller devices 36B are disposed to be spaced apart from each other in the direction in which the pair of rear wing portions 161 extend. The second propellers 361 of the second propeller devices 36B are disposed in a manner so as to face rearward with respect to the rear wing 16B. The second propellers 361 are connected to the rotation shafts 32 of the motive power devices 30.

In the second propeller devices 36B, the second propellers 361 are disposed to be capable of rotating in a forward direction and a reverse direction about the rotation shafts 32. Hereinafter, the forward rotation of the second propellers 361 may also be referred to as a second forward rotation, and the reverse rotation of the second propellers 361 may also be referred to as a second reverse rotation. By being operated by the non-illustrated pilot, the second propellers 361 undergo the second reverse rotation based on a control signal from the control device 26, whereby the second propellers 361 generate a second frontward airflow SF2 that flows frontward. By being operated by the non-illustrated pilot, the second propellers 361 undergo the second forward rotation, whereby the second propellers 361 generate the second rearward airflow SR2 that flows rearward. The second rearward airflow SR2 becomes a thrust force when the flying object 10B moves frontward.

Moreover, it should be noted that the second propulsion devices 22B are not necessarily limited to having a configuration that is capable of generating the second frontward airflow SF2 that flows frontward. For example, it is sufficient that either the first propulsion devices 20B or the second propulsion devices 22B are capable of generating the frontward airflow.

The flaps 24B are equipped with the first flaps 241A and second flaps 242B.

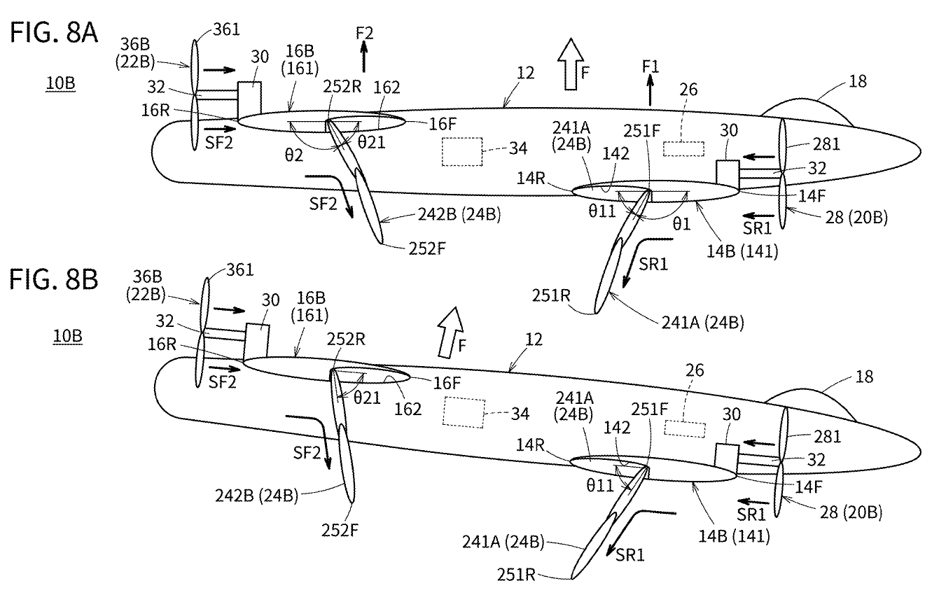

As shown in FIG. 7, the first flaps 241A are disposed on the front wing 14B in a tiltable manner. As shown in FIG. 8A, the first flaps 241A are disposed in a manner so as to be capable of deflecting the direction of the first rearward airflow SR1 that is generated by the first propulsion devices 20B (refer to FIG. 8A). As shown in FIG. 6, the first flaps 241A are disposed on the pair of front wing portions 141, respectively. The first flaps 241A are disposed rearward of the first propulsion devices 20B. Moreover, since the pair of first flaps 241A have the same configuration as the pair of first flaps 241A in the first embodiment, the same reference numerals are applied thereto, and detailed description thereof is omitted.

As shown in FIG. 7, the second flaps 242B are disposed on the rear wing 16B in a tiltable manner. As shown in FIG. 8A, the second flaps 242B are disposed in a manner so as to be capable of deflecting the direction of the second frontward airflow SF2 that is generated by the second propulsion devices 22B. As shown in FIG. 6, the second flaps 242B are disposed on the pair of rear wing portions 161, respectively. More specifically, a pair of the second flaps 242B are provided.

The pair of second flaps 242B are disposed on the front end parts 16F of the rear wing portions 161. In the respective rear wing portions 161, the second flaps 242B are disposed frontward of the second propulsion devices 22B. The respective second flaps 242B are disposed in the second storage units 162 that are formed in the front end parts 16F of the rear wing portions 161. The respective second storage units 162 are disposed on the front end parts 16F of the rear wing portions 161.

As shown in FIG. 8A, the rear end parts 252R of the second flaps 242B are supported in a tiltable manner by the rear wing portions 161 in the interior of the second storage units 162. The respective second flaps 242B include the front end parts 252F that are capable of tilting about the rear end parts 252R with respect to the rear wing portions 161. When the respective second flaps 242B are in a tilted position, the front end parts 252F of the second flaps 242B are tilted downward with respect to the rear wing portions 161 about the rear end parts 252R, and the front end parts 252F are disposed lower than the rear wing portions 161.

In the tilted position of the second flaps 242B, the second frontward airflow SF2 that is generated by the second propulsion devices 22B and that flows along the lower part of the rear wing 16B can be deflected downward by the second flaps 242B. The position of each of the second flaps 242B can be adjusted by the operation of the non-illustrated pilot.

As shown in FIG. 6, the flying object 10B further includes the battery 34. The battery 34 is disposed in a central part of the fuselage 12 in the front-rear direction. In the front-rear direction of the fuselage 12, the battery 34 is disposed between the front wing 14B and the rear wing 16B. The battery 34 is disposed in closer proximity to the rear wing 16B than to the front wing 14B.

Next, a description will be given concerning operations of the flying object 10B.

First, when the flying object 10B carries out the vertical takeoff from a landed state, as shown in FIG. 8A, each of the first flaps 241A and the second flaps 242B are placed in a tilted position. Specifically, the rear end parts 251R of the first flaps 241A are disposed lower than the front wing 14B, and the front end parts 252F of the second flaps 242B are disposed lower than the rear wing 16B. Then, the first propulsion devices 20B and the second propulsion devices 22B are driven. The first propellers 281 of the plurality of first propeller devices 28 undergo the first forward rotation. By the first forward rotation of the plurality of first propeller devices 28, the first rearward airflow SR1 toward the rear of the first propeller devices 28 is generated. By the second propellers 361 of the plurality of second propeller devices 36B undergoing the second reverse rotation, the second frontward airflow SF2 toward the front of the second propeller devices 36B is generated.

The first rearward airflow SR1 that is generated by the plurality of first propulsion devices 20B is deflected downward by hitting against each of the pair of first flaps 241A. The first rearward airflow SR1 that is deflected downward becomes the first ascending thrust force F1 that causes the fuselage 12 to ascend in the vertical direction. The second frontward airflow SF2 that is generated by the plurality of second propulsion devices 22B is deflected downward by each of the pair of second flaps 242B. The second frontward airflow SF2 that is deflected downward becomes the second ascending thrust force F2 that causes the fuselage 12 to ascend in the vertical direction. The front part of the flying object 10B is made to rise by the first ascending thrust force F1, and the rear part of the flying object 10B is made to rise by the second ascending thrust force F2. In accordance therewith, the flying object 10B separates away in the vertical direction and takes off.

At this time, by adjusting the output of the first propulsion devices 20B and thereby controlling the flow rate of the first rearward airflow SR1, and by adjusting the output of the second propulsion devices 22B and thereby controlling the flow rate of the second frontward airflow SF2, it is possible to control a pitch movement of the flying object 10B.

Next, after the flying object 10B has taken off, as shown in FIG. 8B, by making the output of the second propulsion devices 22B relatively larger than the output of the first propulsion devices 20B, and by making the second flap angle θ21 of the second flaps 242B relatively larger than the first flap angle θ11 of the first flaps 241A, the fuselage 12 is made to assume a frontwardly inclined attitude in which the rear part thereof is positioned higher than the front part thereof. More specifically, by intentionally making the second ascending thrust force F2 greater than the first ascending thrust force F1, the fuselage 12 is made to assume a frontwardly inclined attitude so that the vector direction of the thrust force F points diagonally frontward. Moreover, by making one or more of the output adjustment of the first propulsion devices 20B and the second propulsion devices 22B, and the angle adjustment of the first flaps 241A and the second flaps 242B, the fuselage 12 may be made to assume a frontwardly inclined attitude.

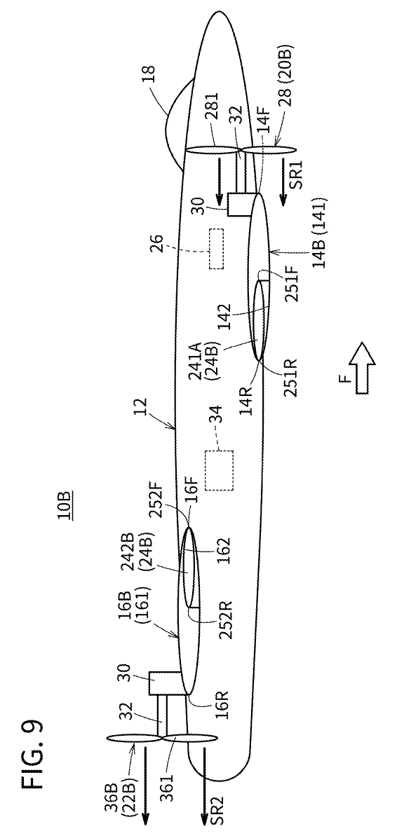

Together with adjusting the output of the first propulsion devices 20B and the second propulsion devices 22B, by adjusting the first flap angle θ11 of the first flaps 241A and the second flap angle θ21 of the second flaps 242B in a manner so as to become gradually smaller, the attitude control is carried out in a manner so that the fuselage 12 becomes horizontal. As shown in FIG. 9, in a state in which the fuselage 12 of the flying object 10B has become horizontal, the first flaps 241A and the second flaps 242B are made horizontal, and the first flaps 241A and the second flaps 242B are stored respectively in the first storage units 142 and the second storage units 162. The first propulsion devices 20B are maintained to undergo the first forward rotation, and the second propulsion devices 22B are switched from the second reverse rotation to the second forward rotation. In accordance therewith, the second rearward airflow SR2 is generated by the second propulsion devices 22B, and together with the first rearward airflow SR1 that is generated by the first propulsion devices 20B, the thrust force F that causes the fuselage 12 to move frontward is obtained. The flying object 10B moves horizontally frontward.

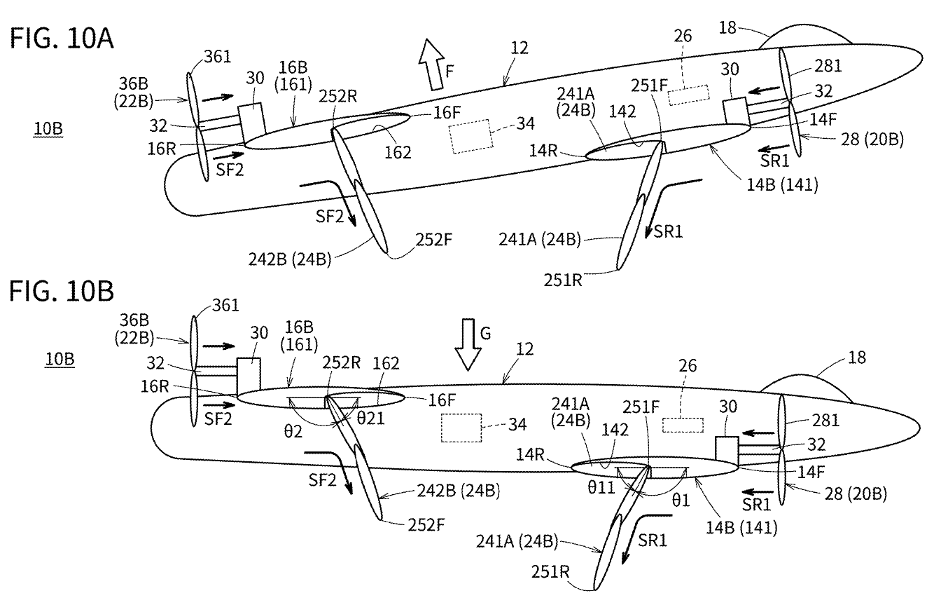

Next, in the case of causing the flying object 10B to land, the output of the first propulsion devices 20B and the second propulsion devices 22B is gradually reduced, and as shown in FIG. 10A, the first flaps 241A and the second flaps 242B are tilted. The first flaps 241A and the second flaps 242B are placed in a tilted position. By adjusting one or more of the direction of the airflow generated by the first propulsion devices 20B and the second propulsion devices 22B, and the angle of the first flaps 241A and the second flaps 242B, the control device 26 controls the fuselage 12 to assume a rearwardly inclined attitude so that the rear part of the fuselage 12 is positioned lower than the front part thereof.

Then, as shown in FIG. 10B, after the altitude of the flying object 10B has become less than or equal to a predetermined altitude, a control is carried out by the control device 26 in a manner so as to cancel out a resultant force of a first thrust force oriented in the front-rear direction of the fuselage 12 and a second thrust force oriented in the front-rear direction of the fuselage 12 by adjusting the output of the first propulsion devices 20B and the first flap angle θ11 of the first flaps 241A, and by adjusting the output of the second propulsion devices 22B and the second flap angle θ21 of the second flaps 242B. In accordance therewith, the flying object 10B does not move in the front-rear direction, but the flying object 10B gradually descends in the vertical direction due to gravity and becomes placed in the landed state.

The second embodiment exhibits the following advantageous effects.

As shown in FIG. 8A, either or both of the first propulsion devices 20B and the second propulsion devices 22B are capable of generating the frontward airflow (the second frontward airflow SF2).

In accordance with this configuration, by switching the direction of the airflow generated by the second propulsion devices 22B, the vertical takeoff and landing of the flying object 10B can be achieved with a simple configuration.

As shown in FIG. 7, the flaps 24B comprise the first flaps 241A that are disposed on the front wing 14B, and the second flaps 242B that are disposed on the rear wing 16B.

In accordance with this configuration, the flowing of each of the first rearward airflow SR1 and the second rearward airflow SR2 can be effectively deflected downward by the first flaps 241A and the second flaps 242B, and therefore, the flying object 10B can be made to move effectively in the vertical direction.

The first flaps 241A are disposed rearward of the first propulsion devices 20B, and the second flaps 242B are disposed frontward of the second propulsion devices 22B. As shown in FIG. 8A, when the flying object 10B carries out the vertical takeoff and landing, the first rearward airflow SR1 that is generated by the first propulsion devices 20B is deflected downward by the first flaps 241A, and the second frontward airflow SF2 that is generated by the second propulsion devices 22B is deflected downward by the second flaps 242B.

In accordance with this configuration, by the airflow that is deflected by the first flaps 241A and the second flaps 242B, the central part of the fuselage 12 in the front-rear direction can be made to rise upward effectively.

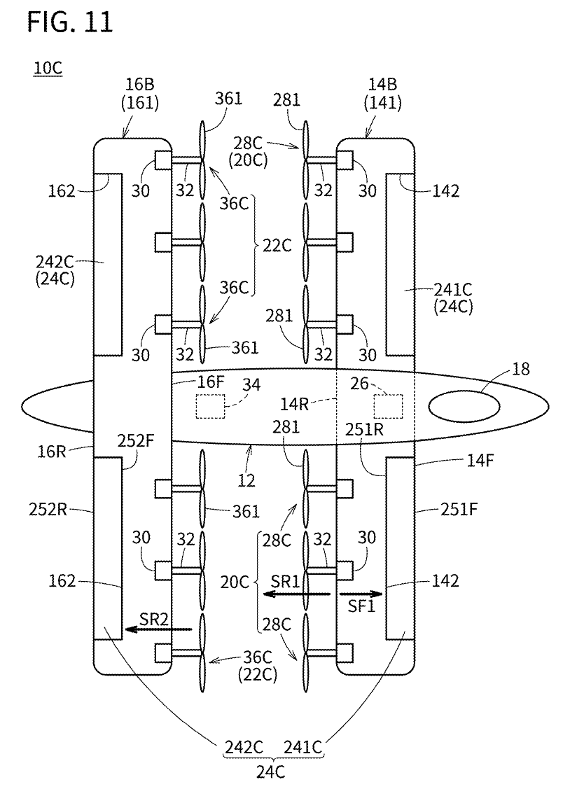

As shown in FIG. 11, a flying object 10C according to a third embodiment is equipped with first propulsion devices 20C, second propulsion devices 22C, and flaps 24C.

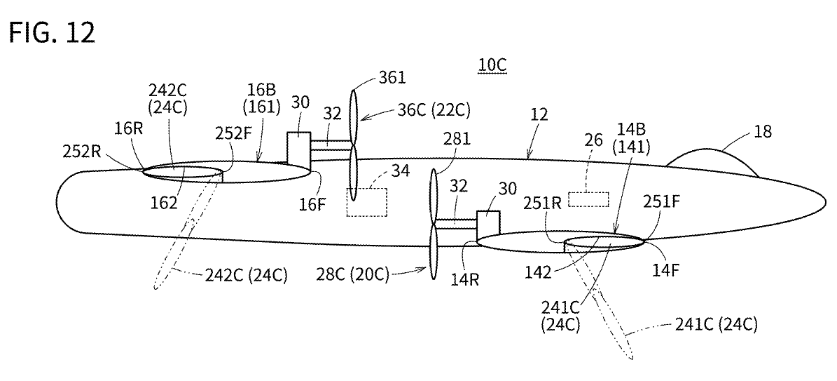

The first propulsion devices 20C are disposed on the front wing 14B and are capable of generating at least the first rearward airflow SR1. The first propulsion devices 20C are equipped with a plurality of first propeller devices 28C. The plurality of first propeller devices 28C are disposed on the upper part of each of the pair of front wing portions 141 (refer to FIG. 12). The plurality of first propeller devices 28C are disposed on the rear end part 14R of the front wing 14B.

The second propulsion devices 22C are disposed on the rear wing 16B and are capable of generating at least the second rearward airflow SR2. The second propulsion devices 22C are equipped with a plurality of second propeller devices 36C. The plurality of second propeller devices 36C are disposed on the upper part of each of the pair of rear wing portions 161 (refer to FIG. 12). The plurality of second propeller devices 36C are disposed on the front end part 16F of the rear wing 16B. In the front-rear direction of the fuselage 12, the first propulsion devices 20C and the second propulsion devices 22C face each other.

The flaps 24C comprise first flaps 241C and second flaps 242C.

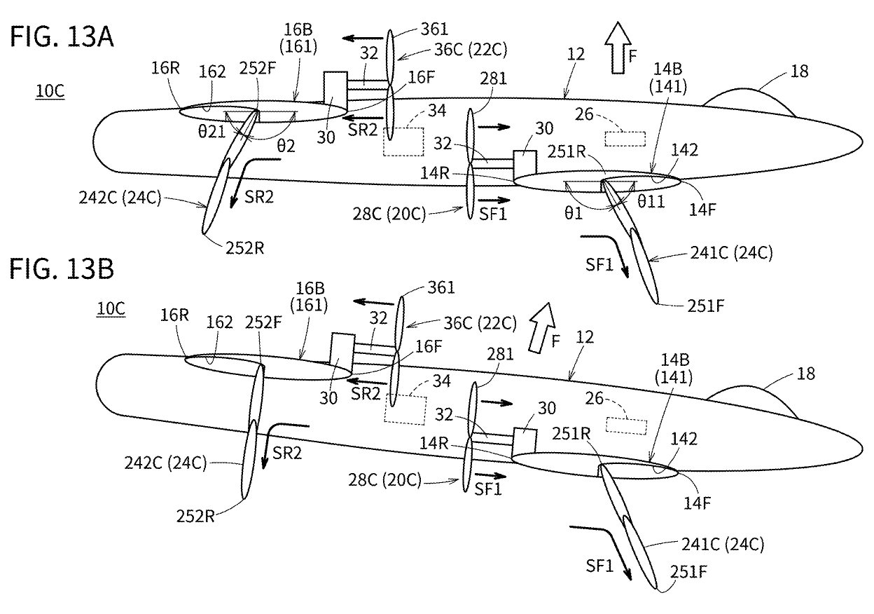

The first flaps 241C are disposed on the front end part 14F of the front wing 14B. The first flaps 241C are disposed frontward of the first propulsion devices 20C on the front wing 14B. As shown in FIG. 13A, the rear end parts 251R of the first flaps 241C are supported in a tiltable manner on the front wing 14B. The first flaps 241C are capable of deflecting downward a first frontward airflow SF1 that is generated by the first propulsion devices 20C.

As shown in FIG. 11, the second flaps 242C are disposed on the rear end part 16R of the rear wing 16B. The second flaps 242C are disposed rearward of the second propulsion devices 22C on the rear wing 16B. As shown in FIG. 13A, the front end parts 252F of the second flaps 242C are supported in a tiltable manner on the rear wing 16B. The second flaps 242C are capable of deflecting downward the second rearward airflow SR2 that is generated by the second propulsion devices 22C.

Next, a description will be given concerning operations of the flying object 10C.

First, when the flying object 10C carries out the vertical takeoff, as shown in FIG. 13A, the first frontward airflow SF1 that is generated by the first propulsion devices 20C is deflected downward by the first flaps 241C, which are in the tilted position, and the second rearward airflow SR2 that is generated by the second propulsion devices 22C is deflected downward by the second flaps 242C. By the first frontward airflow SF1 that is deflected by the first flaps 241C and the second rearward airflow SR2 that is deflected by the second flaps 242C, a state is brought about in which the flying object 10C takes off in the vertical direction.

Next, after the flying object 10C has taken off, as shown in FIG. 13B, by making the output of the second propulsion devices 22C relatively larger than the output of the first propulsion devices 20C, the fuselage 12 is made to assume a frontwardly inclined attitude in which the rear part thereof is positioned higher than the front part thereof. Moreover, by the control device 26 adjusting one or more of the output of the first propulsion devices 20C and the second propulsion devices 22C, and the angle of the first flaps 241C and the second flaps 242C, the fuselage 12 may be controlled to assume a frontwardly inclined attitude in which the rear part of the fuselage 12 is positioned higher than the front part thereof.

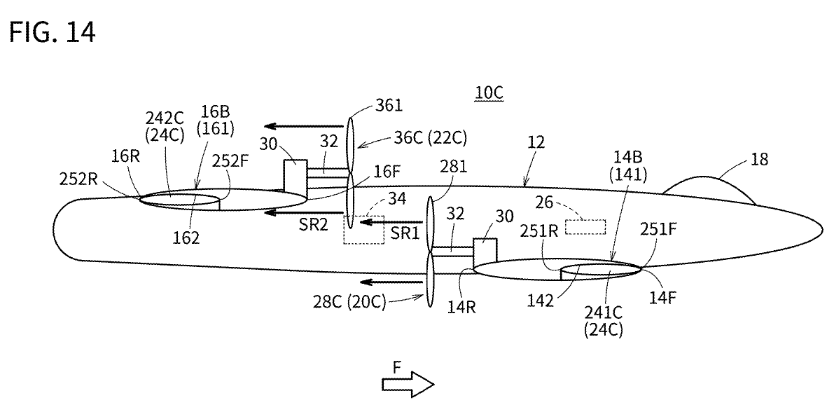

Then, together with adjusting the output of the first propulsion devices 20C and the second propulsion devices 22C, the first flap angle θ11 of the first flaps 241C and the second flap angle θ21 of the second flaps 242C are adjusted in a manner so as to become gradually smaller. In accordance therewith, the attitude control is carried out in a manner so that the fuselage 12 becomes horizontal. As shown in FIG. 14, in a state in which the fuselage 12 of the flying object 10C has become horizontal, and the first flaps 241C and the second flaps 242C have become horizontal, the first flaps 241C and the second flaps 242C are stored respectively in the first storage units 142 and the second storage units 162.

In the state in which the fuselage 12 has become substantially horizontal, the second propulsion devices 22C are maintained to undergo the second forward rotation, and the first propulsion devices 20C are switched from the first reverse rotation to the first forward rotation. In accordance therewith, the first rearward airflow SR1 is generated by the first propulsion devices 20C, and together with the second rearward airflow SR2 that is generated by the second propulsion devices 22C, the thrust force F that causes the fuselage 12 to move frontward is obtained.

The third embodiment exhibits the following advantageous effects.

As shown in FIG. 11, the first flaps 241C are disposed frontward of the first propulsion devices 20C, and the second flaps 242C are disposed rearward of the second propulsion devices 22C. As shown in FIG. 13A, when a vertical takeoff and landing is carried out, the first frontward airflow SF1 that is generated by the first propulsion devices 20C is deflected downward by the first flaps 241C. The second rearward airflow SR2 that is generated by the second propulsion devices 22C is deflected downward by the second flaps 242C.

In accordance with this configuration, by the first propulsion devices 20C and the second propulsion devices 22C, which are heavy objects, being disposed in the central part of the fuselage 12 in the front-rear direction, the balance efficiency in the front-rear direction of the fuselage 12 can be improved.

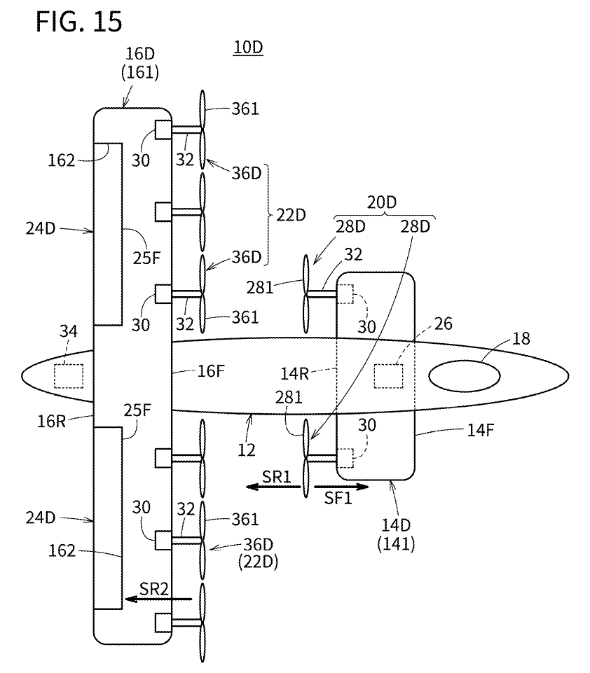

As shown in FIG. 15, a flying object 10D according to a fourth embodiment is equipped with a front wing 14D, a rear wing 16D, a first propulsion device 20D, second propulsion devices 22D, and flaps 24D.

In a plan view of the fuselage 12, the front wing 14D is formed to be smaller than the rear wing 16D. In the widthwise direction of the flying object 10D, each of the front wing portions 141 of the front wing 14D is smaller than each of the rear wing portions 161 of the rear wing 16D. In the front-rear direction of the fuselage 12, each of the front wing portions 141 of the front wing 14D is smaller than each of the rear wing portions 161 of the rear wing 16D. In this case, the rear wing 16D functions as a main wing of the flying object 10D, and the front wing 14D functions as a canard (an air stabilizing wing) that serves to stabilize the attitude of the flying object 10D during flight. The front wing 14D suppresses a pitch movement in the front-rear direction about an axis that extends in the widthwise direction of the fuselage 12. Moreover, the front wing 14D is not limited to having a configuration of being smaller than the rear wing 16D. For example, the front wing 14D and the rear wing 16D may be of the same size.

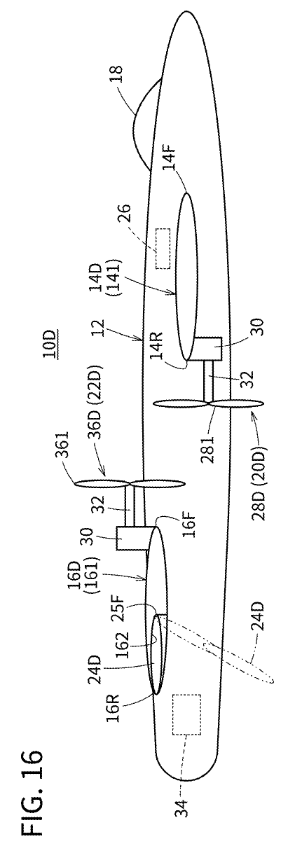

The first propulsion device 20D is disposed on the rear end part 14R of the front wing 14D. The first propulsion device 20D is disposed in a manner so as to extend rearward from the rear end part 14R of the front wing 14D (refer to FIG. 16). The first propulsion device 20D is equipped with a plurality of first propeller devices 28D. Hereinafter, a description will be given concerning a configuration in which the first propulsion device 20D is equipped with a pair of the first propeller devices 28D. Each of the pair of front wing portions 141 is equipped with one of the first propeller devices 28D. In each of the first propeller devices 28D, the first propeller 281 is disposed to be capable of rotating in a forward direction and a reverse direction about the rotation shaft 32. Moreover, it should be noted that the first propulsion device 20D may be equipped with two or more of the first propeller devices 28D.

The second propulsion devices 22D are disposed on the front end part 16F of the rear wing 16D. The second propulsion devices 22D are disposed in a manner so as to extend frontward from the front end part 16F of the rear wing 16D (refer to FIG. 16). The second propulsion devices 22D are equipped with a plurality of second propeller devices 36D. The number of the second propeller devices 36D is greater than the number of the first propeller devices 28D. Moreover, the number of the second propeller devices 36D and the number of the first propeller devices 28D may be the same. Hereinafter, a description will be given concerning a configuration in which the second propulsion devices 22D are equipped with six of the second propeller devices 36D. In each of the second propeller devices 36D, the second propeller 361 is disposed to be capable of rotating in a forward direction and a reverse direction about the rotation shaft 32. Moreover, it should be noted that the second propulsion devices 22D may be equipped with five or less, or seven or more of the second propeller devices 36D.

The flaps 24D are disposed on the rear wing 16D. The flaps 24D are disposed on the rear end part 16R of the rear wing 16D. The flaps 24D are disposed rearward of the second propulsion devices 22D on the rear wing 16D. The flaps 24D are disposed only on the rear wing 16D from among the front wing 14D and the rear wing 16D. Front end parts 25F of the flaps 24D are supported in a tiltable manner on the rear wing 16D. The flaps 24D are capable of deflecting downward the second rearward airflow SR2 that is generated by the second propulsion devices 22D.

Next, a description will be given concerning operations of the flying object 10D.

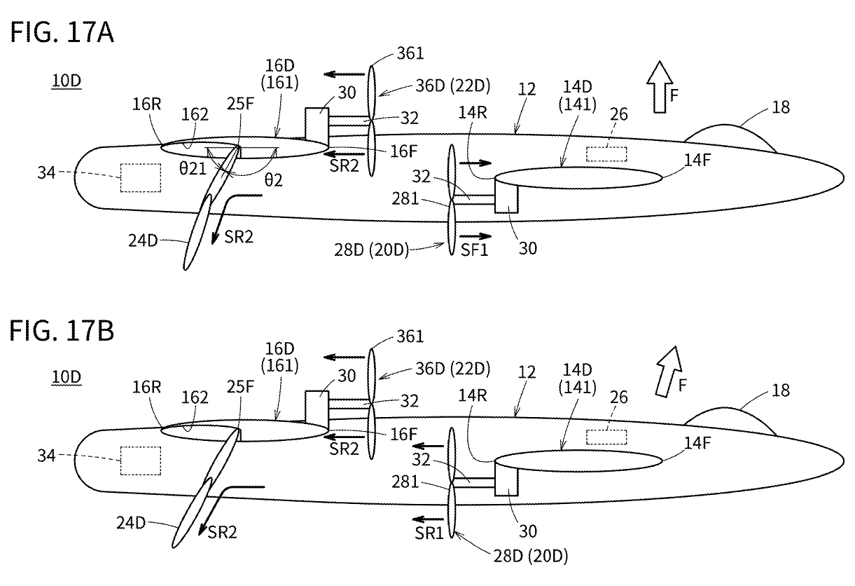

First, when the flying object 10D carries out the vertical takeoff, as shown in FIG. 17A, the first propulsion device 20D undergoes the first reverse rotation to generate the first frontward airflow SF1, and further, the second propulsion devices 22D undergo the second forward rotation to generate the second rearward airflow SR2. The second rearward airflow SR2 is deflected downward by the flaps 24D that are in the tilted position. By the second rearward airflow SR2 being deflected by the flaps 24D, the rear part of the fuselage 12 rises due to the thrust F. At this time, by balancing the first frontward airflow SF1 generated by the first propulsion device 20D and the second rearward airflow SR2, the fuselage 12 is prevented from moving frontward. Then, as shown in FIG. 17B, the first propulsion device 20D undergoes the first forward rotation to generate the first rearward airflow SR1, and the attitude of the fuselage 12 is controlled in a manner so that the direction of the thrust force F with respect to the fuselage 12 is oriented diagonally frontward.

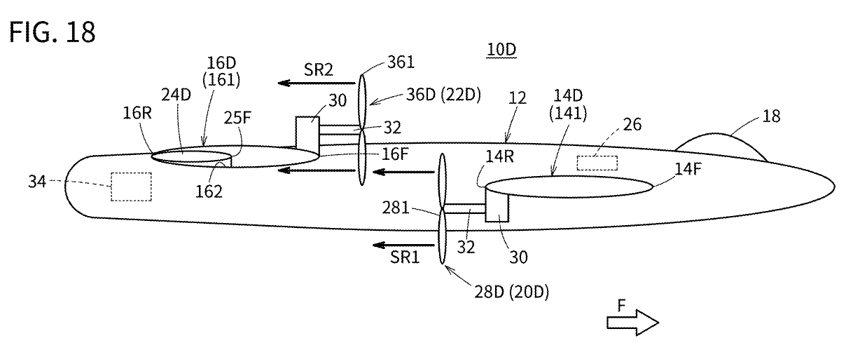

As shown in FIG. 18, after the fuselage 12 has ascended and been placed in a substantially horizontal state, the flaps 24D are placed in a state of being parallel to the rear wing 16D, and while the second propulsion devices 22D are undergoing the second forward rotation, the first propulsion device 20D is switched from the first reverse rotation to the first forward rotation. In accordance therewith, the first rearward airflow SR1 is generated by the first propulsion device 20D, and due to the first rearward airflow SR1, the thrust force F that is directed forwardly acts on the fuselage 12.

Then, by controlling the flap angle θ21 (refer to FIG. 17A) of the flaps 24D to gradually decrease, the thrust force F that causes the fuselage 12 to move frontward is obtained by the first rearward airflow SR1 that is generated by the first propulsion device 20D and the second rearward airflow SR2 that is generated by the second propulsion devices 22D and flows rearward. In accordance therewith, the fuselage 12 moves frontward.

The fourth embodiment exhibits the following advantageous effects.

As shown in FIG. 15, the flying object 10D is equipped with the first propulsion device 20D disposed on the front wing 14D, the second propulsion devices 22D disposed on the rear wing 16D, and the flaps 24D that are capable of deflecting the direction of the airflow. The vertical takeoff and landing is carried out by controlling the direction of the airflow generated by the first propulsion device 20D and the second propulsion devices 22D, and the flap angle θ21 of the flaps 24D.

In accordance with this configuration, since the vertical takeoff and landing of the flying object 10D becomes possible without providing a rotor for such vertical takeoff and landing, it is possible to realize a reduction in weight of the flying object 10D.

As shown in FIG. 17A, either or both of the first propulsion device 20D and the second propulsion devices 22D are capable of generating a frontward airflow (the first frontward airflow SF1).

In accordance with this configuration, by switching the direction of the first frontward airflow SF1 generated by the first propulsion device 20D, the vertical takeoff and landing of the flying object 10D can be achieved with a simple configuration.

As shown in FIG. 15, the flaps 24D are disposed rearward of the second propulsion devices 22D. In accordance with this configuration, the configuration can be simplified and made lighter in weight.

In a plan view of the fuselage 12, the front wing 14D is formed to be smaller than the rear wing 16D, the flaps 24D are disposed only on the rear wing 16D from among the front wing 14D and the rear wing 16D, and when carrying out the vertical takeoff and landing, the first frontward airflow SF1 is generated by the first propulsion device 20D, and the second rearward airflow SR2 that is generated by the second propulsion devices 22D is deflected downward by the flaps 24D.

In accordance with this configuration, by providing the flaps 24D on the rear wing 16D, which is larger than the front wing 14D, it is possible to cause the second rearward airflow SR2 to be deflected more effectively.

In relation to the above-described disclosure, the following supplementary notes are further disclosed.

### Supplementary Note 1

The flying object (10A, 10B, 10C, 10D) includes the fuselage (12), the front wing (14A, 14B, 14D) connected to the fuselage, the rear wing (16A, 16B, 16D) connected to the fuselage and disposed more rearward than the front wing, the first propulsion device (20A, 20B, 20C, 20D) disposed on the front wing and capable of generating at least the rearward airflow (SR1), the second propulsion device (22A, 22B, 22C, 22D) disposed on the rear wing and capable of generating at least the rearward airflow (SR2), and the flap (24A, 24B, 24C, 24D) disposed on at least one of the front wing or the rear wing in a tiltable manner, and capable of deflecting the direction of an airflow generated by the first propulsion device or the second propulsion device, wherein the vertical takeoff and landing is carried out by controlling one or more of the direction of the airflow generated by the first propulsion device, the direction of the airflow generated by the second propulsion device, and the angle (θ1, θ2) of the flap.

In accordance with such a flying object, since the vertical takeoff and landing of the flying object becomes possible without providing a rotor for such vertical takeoff and landing, it is possible to realize a reduction in weight of the flying object. Further, the flying object is capable of carrying out the takeoff and landing in locations where there are no runways.

### Supplementary Note 2

In the flying object according to Supplementary Note 1, at least one of the first propulsion device or the second propulsion device may be capable of generating the frontward airflow (SF1, SF2). In accordance with such a configuration, by switching the direction of the airflow generated by the propulsion devices, the vertical takeoff and landing of the flying object can be achieved with a simple configuration.

### Supplementary Note 3

In the flying object according to Supplementary Note 2, the flap may include the first flap (241A, 241C) that is disposed on the front wing, and the second flap (242A, 242B, 242C) that is disposed on the rear wing. In accordance with such a configuration, the flowing of each of the frontward airflow and the rearward airflow can be effectively deflected downward, and therefore, the flying object can be made to move effectively in the vertical direction.

### Supplementary Note 4

In the flying object according to Supplementary Note 3, the first flap may be disposed rearward of the first propulsion device, the second flap may be disposed rearward of the second propulsion device, and when carrying out the vertical takeoff and landing, the rearward airflow that is generated by the first propulsion device may be deflected downward by the first flap, and the rearward airflow that is generated by the second propulsion device may be deflected downward by the second flap. In accordance with such a configuration, the rearward airflow can be effectively deflected downward by the first flap and the second flap.

### Supplementary Note 5

In the flying object according to Supplementary Note 3, the first flap may be disposed rearward of the first propulsion device, the second flap may be disposed frontward of the second propulsion device, and when carrying out the vertical takeoff and landing, the rearward airflow that is generated by the first propulsion device may be deflected downward by the first flap, and the frontward airflow that is generated by the second propulsion device may be deflected downward by the second flap. In accordance with such a configuration, by the airflow that is deflected by the first flap and the second flap, the central part of the fuselage in the front-rear direction can be made to rise upward.

### Supplementary Note 6

In the flying object according to Supplementary Note 3, the first flap may be disposed frontward of the first propulsion device, the second flap may be disposed rearward of the second propulsion device, and when carrying out the vertical takeoff and landing, the frontward airflow that is generated by the first propulsion device may be deflected downward by the first flap, and the rearward airflow that is generated by the second propulsion device may be deflected downward by the second flap. In accordance with such a configuration, by the first propulsion device and the second propulsion device, which are heavy objects, being disposed in the central part of the fuselage in the front-rear direction, the balance efficiency in the front-rear direction of the fuselage can be improved.

### Supplementary Note 7

In the flying object according to Supplementary Note 1 or 2, the flap may be disposed rearward of the second propulsion device. In accordance with such a configuration, the configuration can be simplified and made lighter in weight.

### Supplementary Note 8

In the flying object according to Supplementary Note 7, in a plan view of the fuselage, the front wing may be formed to be smaller than the rear wing, the flap may be disposed only on the rear wing from among the front wing and the rear wing, and when carrying out the vertical takeoff and landing, the frontward airflow may be generated by the first propulsion device, and the rearward airflow that is generated by the second propulsion device may be deflected downward by the flap. In accordance with such a configuration, by providing the flap on the rear wing, which is larger than the front wing, it is possible to cause the rearward airflow to be deflected more effectively.

### Supplementary Note 9

The control method is a control method for the flying object that includes the fuselage, the front wing connected to the fuselage, the rear wing connected to the fuselage and disposed more rearward than the front wing, the first propulsion device disposed on the front wing and capable of generating at least the rearward airflow, the second propulsion device disposed on the rear wing and capable of generating at least the rearward airflow, the first flap disposed on the front wing in a tiltable manner, and capable of deflecting the direction of the airflow generated by the first propulsion device, and the second flap disposed on the rear wing in a tiltable manner, and capable of deflecting the direction of the airflow generated by the second propulsion device, the control method for the flying object including generating the first thrust force oriented in the front-rear direction of the fuselage by respectively adjusting the direction of the airflow generated by the first propulsion device and the angle of the first flap, generating the second thrust force oriented in the front-rear direction of the fuselage by respectively adjusting the direction of the airflow generated by the second propulsion device and the angle of the second flap, and controlling the fuselage so as to move in a vertical direction by substantially cancelling out a resultant force of the first thrust force and the second thrust force.

In accordance with such a method of controlling the flying object, the first thrust force from the first propulsion device and the second thrust force from the second propulsion device can be effectively canceled out by respectively adjusting the angles of the first flap and the second flap, and the thrust force in the vertical direction of the flying object can be generated. In accordance with this feature, even in locations where there are no runways, the flying object is capable of carrying out the takeoff and landing.

### Supplementary Note 10

The flying object includes the fuselage, the front wing connected to the fuselage, the rear wing connected to the fuselage and disposed more rearward than the front wing, the first propulsion device disposed on the front wing and capable of generating at least the rearward airflow, the second propulsion device disposed on the rear wing and capable of generating at least the rearward airflow, the flap capable of deflecting the direction of an airflow generated by the first propulsion device or the second propulsion device, and the control device that causes the first thrust force oriented in the front-rear direction of the fuselage to be generated by adjusting the direction of the airflow generated by the first propulsion device and the angle of the flap, causes the second thrust force oriented in the front-rear direction of the fuselage to be generated by adjusting the direction of the airflow generated by the second propulsion device and the angle of the flap, and controls the fuselage so as to move in a vertical direction without substantially moving in the front-rear direction by adjusting the first thrust force and the second thrust force.

### Supplementary Note 11

In the flying object according to Supplementary Note 10, at least one of the first propulsion device or the second propulsion device is capable of selectively generating the rearward airflow and the frontward airflow.

Although the present disclosure has been described in detail, the present disclosure is not necessarily limited to the individual embodiments described above. These embodiments may be subjected to various additions, substitutions, modifications, partial deletions and the like, within a range that does not deviate from the essence and gist of the present disclosure, or the spirit of the present disclosure as derived from the contents described in the claims and equivalents thereof. Further, the embodiments can also be implemented in combination. For example, in the above-described embodiments, the order of the operations and the order of the processes are illustrated as examples, and the present

disclosure is not necessarily limited to these features. Further, the same also applies to cases in which numerical values or mathematical expressions are used in the description of the aforementioned embodiments.

1. A flying object, comprising:
a fuselage;
a front wing connected to the fuselage;
a rear wing connected to the fuselage and disposed more rearward than the front wing;
a first propulsion device disposed on the front wing and configured to generate at least a rearward airflow;
a second propulsion device disposed on the rear wing and configured to generate at least a rearward airflow; and
a flap disposed on at least one of the front wing or the rear wing in a tiltable manner, and configured to deflect a direction of an airflow generated by the first propulsion device or the second propulsion device,
wherein a vertical takeoff and landing is carried out by controlling one or more of the direction of the airflow generated by the first propulsion device, the direction of the airflow generated by the second propulsion device, and an angle of the flap.

2. The flying object according to claim 1, wherein at least one of the first propulsion device or the second propulsion device is configured to generate a frontward airflow.

3. The flying object according to claim 2, wherein the flap includes:
a first flap disposed on the front wing; and
a second flap disposed on the rear wing.

4. The flying object according to claim 3, wherein:
the first flap is disposed rearward of the first propulsion device;
the second flap is disposed rearward of the second propulsion device; and
when carrying out the vertical takeoff and landing, the rearward airflow that is generated by the first propulsion device is deflected downward by the first flap, and the rearward airflow that is generated by the second propulsion device is deflected downward by the second flap.

5. The flying object according to claim 3, wherein:
the first flap is disposed rearward of the first propulsion device;
the second flap is disposed frontward of the second propulsion device; and
when carrying out the vertical takeoff and landing, the rearward airflow that is generated by the first propulsion device is deflected downward by the first flap, and a frontward airflow that is generated by the second propulsion device is deflected downward by the second flap.

6. The flying object according to claim 3, wherein:
the first flap is disposed frontward of the first propulsion device;
the second flap is disposed rearward of the second propulsion device; and
when carrying out the vertical takeoff and landing, a frontward airflow that is generated by the first propulsion device is deflected downward by the first flap, and the rearward airflow that is generated by the second propulsion device is deflected downward by the second flap.

7. The flying object according to claim 1, wherein the flap is disposed rearward of the second propulsion device.

8. The flying object according to claim 7, wherein:
in a plan view of the fuselage, the front wing is formed to be smaller than the rear wing;
the flap is disposed only on the rear wing from among the front wing and the rear wing; and
when carrying out the vertical takeoff and landing, a frontward airflow is generated by the first propulsion device, and the rearward airflow that is generated by the second propulsion device is deflected downward by the flap.

9. A control method for a flying object,
the flying object including:
a fuselage;
a front wing connected to the fuselage;
a rear wing connected to the fuselage and disposed more rearward than the front wing;
a first propulsion device disposed on the front wing and configured to generate at least a rearward airflow;
a second propulsion device disposed on the rear wing and configured to generate at least a rearward airflow;
a first flap disposed on the front wing in a tiltable manner, and configured to deflect a direction of an airflow generated by the first propulsion device; and
a second flap disposed on the rear wing in a tiltable manner, and configured to deflect a direction of an airflow generated by the second propulsion device,
the control method for the flying object comprising:
generating a first thrust force oriented in a front-rear direction of the fuselage by respectively adjusting the direction of the airflow generated by the first propulsion device and an angle of the first flap;
generating a second thrust force oriented in the front-rear direction of the fuselage by respectively adjusting the direction of the airflow generated by the second propulsion device and an angle of the second flap; and
controlling the fuselage so as to move in a vertical direction by substantially cancelling out a resultant force of the first thrust force and the second thrust force.

10. A flying object, comprising:
a fuselage;
a front wing connected to the fuselage;
a rear wing connected to the fuselage and disposed more rearward than the front wing;
a first propulsion device disposed on the front wing and configured to generate at least a rearward airflow;
a second propulsion device disposed on the rear wing and configured to generate at least a rearward airflow;
a flap configured to deflect a direction of an airflow generated by the first propulsion device or the second propulsion device; and
a control device configured to cause a first thrust force oriented in a front-rear direction of the fuselage to be generated by adjusting the direction of the airflow generated by the first propulsion device and an angle of the flap, cause a second thrust force oriented in the front-rear direction of the fuselage to be generated by adjusting the direction of the airflow generated by the second propulsion device and the angle of the flap, and control the fuselage so as to move in a vertical direction without substantially moving in the front-rear direction by adjusting the first thrust force and the second thrust force.

11. The flying object according to claim 10, wherein
at least one of the first propulsion device or the second propulsion device is configured to selectively generate the rearward airflow and a frontward airflow.
